(19) United States
(12) Patent Application Publication
(10) Pub. No.: US 2020/0151322 A1
(43) Pub. Date: May 14, 2020

(54) METHODS FOR INCREASING AUTHENTICATION SECURITY

(71) Applicant: Microsoft Technology Licensing, LLC, Redmond, WA (US)

(72) Inventors: Amer A. Hassan, Kirkland, WA (US); Russell Andrew Penar, Highlands Ranch, CO (US); Wei-Chen Chen, Redmond, WA (US)

(21) Appl. No.: 16/184,614

(22) Filed: Nov. 8, 2018

(51) Int. Cl. G06F 21/45; H04L 29/08; H04L 29/06

(52) U.S. Cl. CPC G06F 21/45; H04L 63/083; H04L 67/30

(57) ABSTRACT

Methods and systems for authenticating an account based on a password are disclosed. In one aspect, a method includes providing a configuration defining a delay criterion for a delay between at least two characters of a password for an account, providing a user interface configured to set the delay criterion for the account based on input received in the user interface setting a user-configurable value for the delay. If the user-configurable value for the delay is received, the delay criterion for the account is set according to the received user-configurable value. If the user-configurable value for the delay is not received, the delay criterion for the account is set to a system-assigned value for the delay. A notification is also provided conveying the system-assigned value for the delay. An authentication request for the account is received, and the delay criterion is enforced when authenticating the account.

### BACKGROUND

As computing as become increasing pervasive in both economic and personal life, the importance of securing computing information has become paramount. Headlines over the past several years have highlighted the dangers of weak computer security, which may lead to information theft, malicious computer use via the installation of malware, and other problems.

Many computer resources are protected via a combination of account name and password. After authentication information matching a valid account name and password for an account is provided, access to certain computer resources associated with an account may be granted. If a nefarious actor were to obtain a valid account name and password for a computer account, those computer resources are at risk of malicious use. Account names and passwords can be compromised. For example, passwords may be recorded by a user, and then the recordings obtained by a nefarious actor. Therefore, improved methods of protecting this information are desired.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an overview diagram showing an account name or password.

FIG. 2 shows an example user interface including fields, one or more of which may be implemented in at least some of the disclosed embodiments.

FIG. 3 shows a user interface that provides for definition of conditions for applying a delay profile.

FIG. 4 shows an example user interface that may define time criterion for applying a delay profile.

FIG. 5 shows a user interface for defining location criterion for a delay profile.

FIG. 6 shows an example user interface that may be implemented in at least some of the disclosed embodiments.

FIG. 7 shows example data structures, one or more of which that may be maintained by one or more of the disclosed embodiments.

FIG. 8 is an overview diagram of a computer system that implements one or more of the disclosed embodiments.

FIG. 9 shows an example user interface that may be implemented in at least one of the disclosed embodiments.

FIG. 10 is a login screen that may be implemented in one or more of the disclosed embodiments.

FIG. 11 is a flowchart for authenticating an account based on authentication credentials.

FIG. 12A is a flowchart for authenticating an account based on authentication credentials.

FIG. 12B is a continuation of the flowchart described with respect to FIG. 12A.

FIG. 13 illustrates a block diagram of an example machine upon which any one or more of the techniques (e.g., methodologies) discussed herein may perform.

FIG. 14 is a block diagram of an example organization of the instructions discussed with respect to FIG. 13.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, account name and/or password information may be obtained in nefarious ways, leading to compromised computer data. The disclosed embodiments solve this technical problem by providing a technical solution that provides a configurable method of enforcing particular time delays between characters of an account name or a password. A user or an administrator may invoke a user interface that provides for configuration of particular delay criteria between characters in an account name or password. If no delay information is configured for a particular account name or password, delay criteria are automatically assigned to the account name or password by the system. Since the user did not configure these delays the user is informed of the system assigned delay criterion, for example, via a user interface that is displayed after the successful login.

Additionally, the delay requirements between characters may be selectively enforced based on time/date information or a location. Thus, for example, a first set of delays may be enforced when a login is performed for an account from a first location, such as a location near their home or workplace, and a second set of delay criteria may be enforced when a second login is performed from a second location, for example, when traveling.

The present disclosure thus provides a technical solution to the technical problem of compromised authentication credentials by introducing additional requirements for an entered password to be authenticated. The enforced delays provided by the disclosed embodiments may be varied by time/date or location, adding an additional level of unpredictability that may work to prevent a password obtained at a first time or location from successfully facilitating a login from a second time or location.

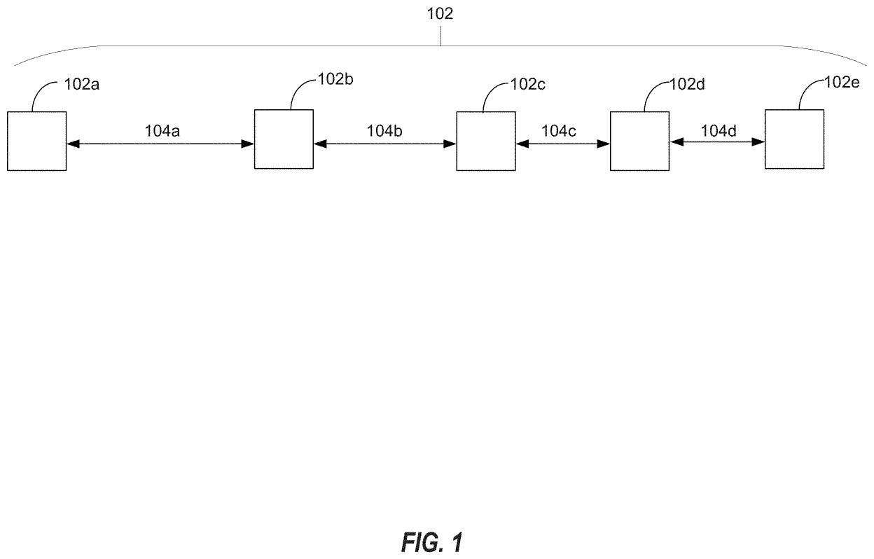

FIG. 1 is an overview diagram showing an account name or password 102. The account name or password 102 includes five characters, shown as 102a-e. Between entry of each of the characters 102a-e is a time delay, shown as 104a-d. Each of the delays 104a-d may be different or the same as other delays. FIG. 1 is not intended to be drawn to scale, in that relative lengths of each delay 104a-d is not intended to imply a relationship between the delays 104a-d. Embodiments of the present disclosure provide for configuration of delays that can augment or modify the delays 104a-d. In some aspects, an acceptable delay range may be configured between each of the characters 102a-e. For example, some embodiments may provide for configuration of a delay range between two and four seconds between characters 102a and 102b, and a delay range of between 0.5 and 1 second between characters 102c and 102d. If no delay range is specified between two particular characters, there may be no delay requirement between those characters. In some aspects, if no delay range is specified between any characters of the account name or password 102, a system assigned delay range between at least two characters (such as a first and second character) may be assigned.

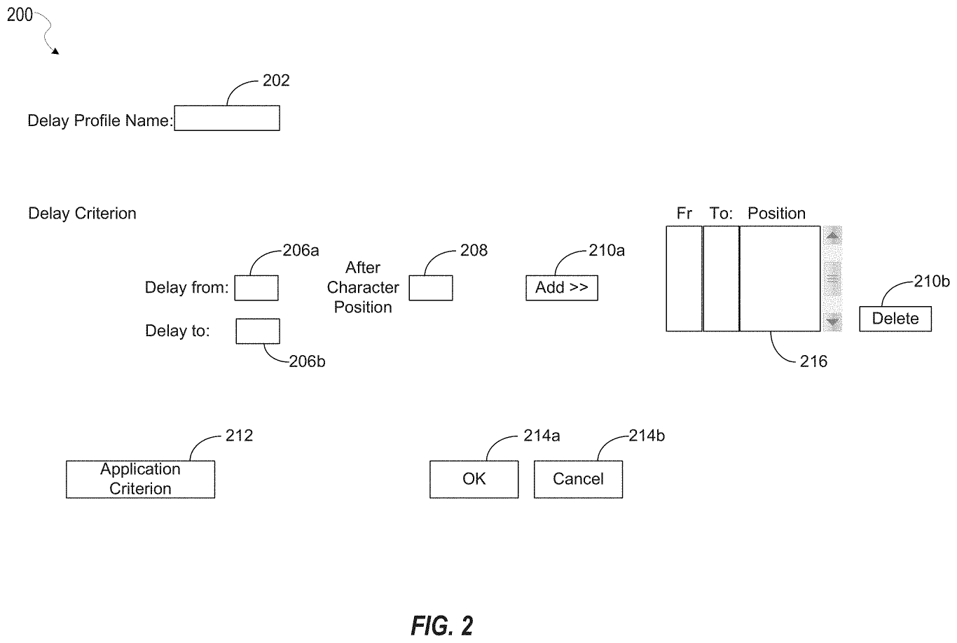

FIG. 2 shows an example user interface 200 including fields, one or more of which may be implemented in at least some of the disclosed embodiments for defining a delay profile. A delay profile defines delays between one or more characters of a password or account entered by a user that are enforced before an account may be successfully authenticated. The user interface 200 includes an edit field 202 for naming a delay profile. The user interface 200 provides for the definition of multiple criterion to be configured in a single delay profile. Each criterion may apply to a particular delay between a particular two characters of an account name or password. A position between characters to which a particular delay criterion applies is defined by the edit box 208. Thus, for example, if a user configures a value of three (3) in edit box 208, the delay configured by that criterion will be enforced between a third and a fourth character in the account name or password to which the delay profile is applied.

The delay criterion specifies an allowable delay range. As shown in interface 200, a starting delay of the range is configured via edit box 206a, while an ending value of the delay range is configured via edit box 206b. Thus, for example, if an acceptable delay between two characters is between 2-3 seconds, edit box 206a may be configured with a value of two (2) while edit box 206b is configured with a value of three (3). To configure an open ended range, either edit box 206a (delay less than) or edit box 206b (delay greater than) may be left blank. While the example embodiment shown in FIG. 2 provides for configuration of both a lower bound of the delay range (via 206a) and an upper bound of the delay range (via 206b), other embodiments may provide for a configuration of a single delay value. These embodiments may then accept some variation from this configured value when authenticating an account. For example, these embodiments may maintain a predefined delay margin, such as ±0.1 sec, ±0.2 secs, etc around this configured delay value. Any delay falling within the configured delay value, ±the predefined delay margin may be considered acceptable delays in these embodiments, with delays falling outside this range considered unacceptable.

While FIG. 2 shows an embodiment that provides for manual entry of a delay range, some embodiments may provide for recording of delays between characters. For example, these embodiments may present a user interface configured to enable recording of delays. After the recording is enabled, a user may type their account or password with delays characteristic of their typing style. These delays may then be used to set the delay range parameters described above.

Once the delay criterion is configured, the add button 210a adds the delay after the character specified in 208 to a list of delay criterion evaluated when the delay profile is applied. The list of delay criterion applied by a particular delay profile is displayed in the list box 216. To delete a delay criterion from the list, the delete key 210b may be used.

The disclosed embodiments may provide delay profiles such as those configured via interface 200 that are applied conditionally based on at least one or more of time, date, or location. To set these conditions, a user may select button 212. An ok button 214a accepts the delay profile defined by the fields of user interface 200 and a cancel button 214b ignores any data entered in the user interface 200.

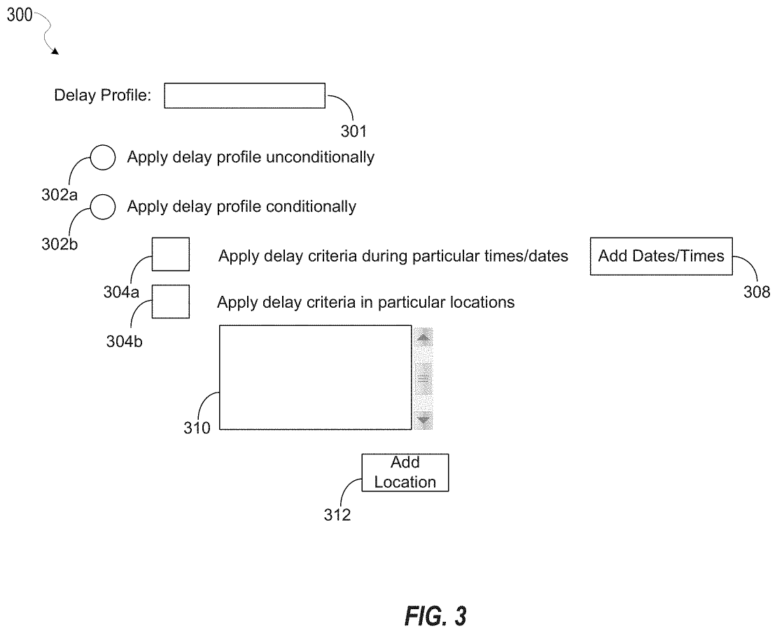

FIG. 3 shows a user interface that provides for definition of conditions for applying a delay profile. In some aspects, the user interface 300 may be launched via selection of the button 212 of user interface 200.

The user interface 300 includes radio buttons 302a-b. Selecting radio button 302a applies the delay profile unconditionally. Selecting radio button 302b causes the delay profile identified by 301 to be applied according to time and or location conditions. Time conditions may be applied to the delay profile when checkbox 304a is selected, while location conditions may be applied to the delay profile when checkbox 304b is selected. The time conditions may be defined via button 308. Location conditions may be defined via button 312. List box 310 displays location condition information for this delay profile (e.g. 301).

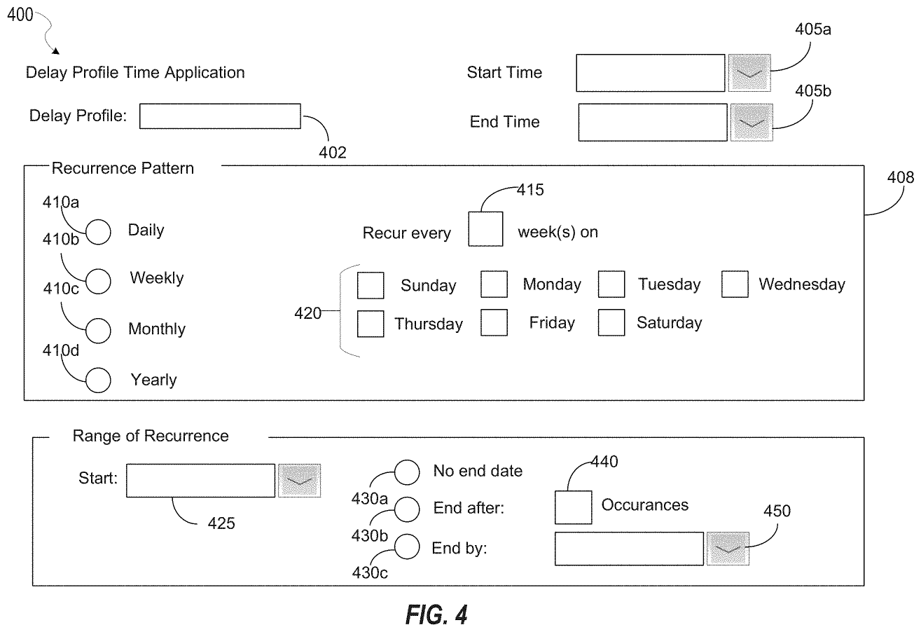

FIG. 4 shows an example user interface that may define time criterion for applying a delay profile. In some aspects, the user interface 400 may be displayed in response to the button 308 of user interface 300.

The user interface 400 is configured to accept input defining a start time 405a and end time 405b to apply the delay profile identified as 402. User interface 400 also is configured to accept input defining a recurrence pattern 408 for application of the delay profile (e.g. 402). The recurrence pattern 408 may be defined as weekly (via radio button 410a), weekly (via radio button 410b), monthly (via radio button 410c), or yearly (via radio button 410d). The recurrence pattern 408 may also be defined to recur a particular number 415 of weeks, and/or to recur on selected days of the week via checkboxes 420.

The recurrence of application of the delay profile (e.g. 402) may be defined to start on a particular date (via 425) and have no end date (via radio button 430a), end after a particular number of occurrences (defined by 440), or end by a particular date (defined by 450).

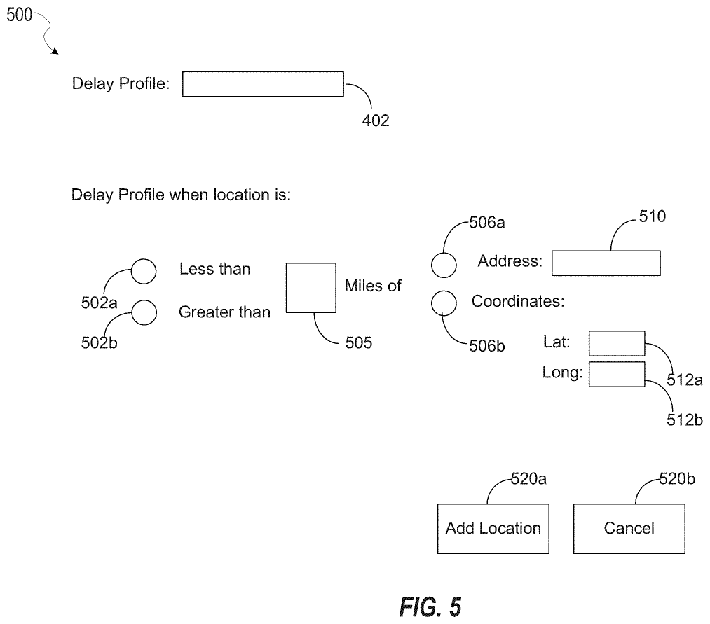

FIG. 5 shows a user interface for defining location criterion for a delay profile. The user interface 500 is defining location criterion for a delay profile identified by the box 502. The location criterion defined by user interface 500 may be greater than or less than a distance from a particular geographic location. Selecting one of radio buttons 502a (less than) or 502b (greater than) determines the nature of the criterion. The user interface 500 is configured to accept input defining the distance via edit box 505. The geographic location may be specified via either an address by selecting radio button 506a and entering an address via list box 510 or coordinates by selecting radio button 506b and entering a latitude via edit box 512a and longitude via edit box 512b. Button 520a adds the location to the list box 310 while cancel button 522b exits user interface 500 without saving any information provided.

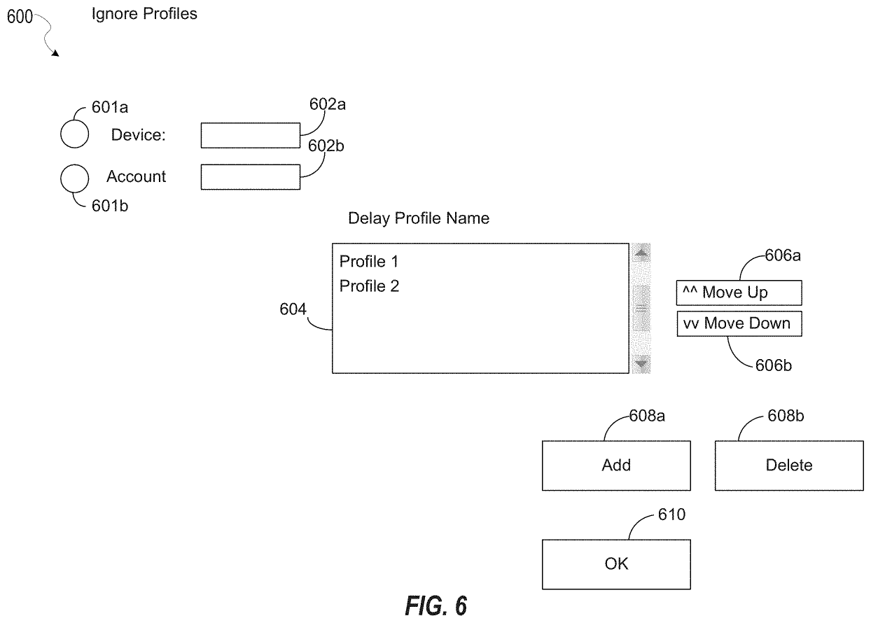

FIG. 6 shows an example user interface that may be implemented in at least some of the disclosed embodiments. The user interface 600 of FIG. 6 provides for the creation and deletion of delay profiles. A list of delay profiles may be created for a device by selecting a radio button 601a and providing a device name or address in the edit box 602a. A list of delay profiles for a user may be created by selecting a radio button 601b and providing an account name in the edit box 602b. The delay profiles for the selected device or account name are listed in the list box 604. As application of various delay profiles listed in the list box 604 may conflict in some time periods or locations, the delay profiles are applied in an order defined by the list box. Some implementations may search through the delay profiles starting at a topmost delay profile in the list box 604 until a delay profile is found that has application criterion that are met. That delay profile is then applied, with any delay profiles lower in the list box 604 not applied. The order of the delay profiles in the list box 604 may be configured via the up and down buttons 606a-b. Button 608a may provide for a new delay profile, for example, by launching the user interface 200. Button 608b may delete a delay profile highlighted in the list box 604. The ok button 610 exits the user interface 600.

In some aspects, the delay profiles displayed by user interface 600 may be synchronized between client and server devices to provide for authentication of the client by the server. For example, the user interfaces of FIGS. 2-6 may be displayed on a client device and data defined locally to the client device. This data may then be synchronized with a server, with the server actually enforcing the delay operations while performing authentication at the server. Alternatively, the client may enforce the delay criterion defined by the data.

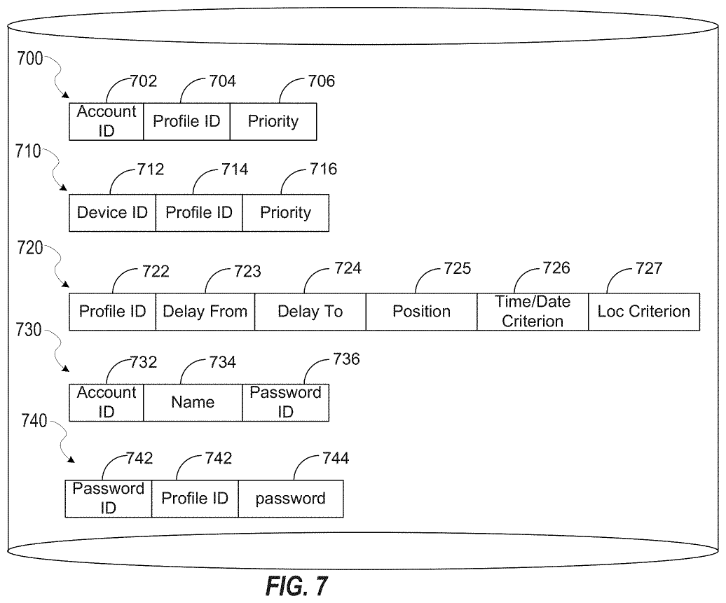

FIG. 7 shows example data structures, one or more of which that may be maintained by one or more of the disclosed embodiments. The data structures discussed below with respect to FIG. 7 may be implemented, in some aspects, as rows in relational database tables. In other embodiments, the data structures may be memory data structures stored in a volatile or non-volatile memory.

FIG. 7 shows an account profile table 700, device profile table 710, profile table 720, and a password table 730. The account profile table 700 includes an account identifier 702, profile identifier 704, and a priority 706. The account identifier 702 uniquely identifies a particular account. The profile identifier 704 uniquely identifies a particular delay profile. The priority 706 defines a priority of evaluation of the delay profile identified by the profile identifier 704 (for example, as defined by an order of the profile in the list box 604 discussed above).

The device profile includes a device identifier 712, profile identifier 714, and a priority 716. The device identifier 712 uniquely identifies a device. The device identifier 712 may be, in various aspects, a station address, UUID, or IP address of a device. The profile identifier 714 uniquely identifies an delay profile. The priority 716 defines a priority of evaluation of the delay profile identified by the profile identifier 714 (for example, as defined by an order of the profile in the list box 604 discussed above).

The delay profile table 720 includes a profile identifier 722, delay from field 723, delay to field 724, position field 725, time/date criterion field 726, location criterion field 727. The profile identifier 722 uniquely identifies a delay profile. The delay from field 723 stores a lower bound of a delay range, for example, as may be entered via the user interface 200, field 206a. If the delay from field 723 is set to a zero value, the delay range may have no lower bound. The delay to field 724 stores an upper bound of the delay range, for example, as may be entered via the user interface 200, field 206b. If the delay to field 724 is set to a zero value, this may indicate the delay has no upper bound. The position field 725 stores a character position in an account name or password after which the delay criterion is applied. For example, the position field 725 may be populated via edit box 208 of user interface 200. The time/data criterion field 726 may store data indicating any one or more of the fields described with respect to FIG. 4. The location criterion field 727 stores data indicating any one or more of the fields described with respect to FIG. 5.

The user table 730 includes an account identifier 732, account name 734 and password identifier 736. The user table 730 may define authentication information for users of a system implementing the disclosed embodiments. The account identifier 732 may be cross referenced with account identifier 702. The account name field 734 defines an account name, and the password id 736 defines a password id for the account identified by the user account identified via the account name 734. The password table 740 includes a password identifier 742 and a password 744. The password identifier 742 may be cross referenced with the password id 736. The present embodiments may apply one or more delay profiles as discussed above to one or more of data stored in the account name field 734 or password field 744.

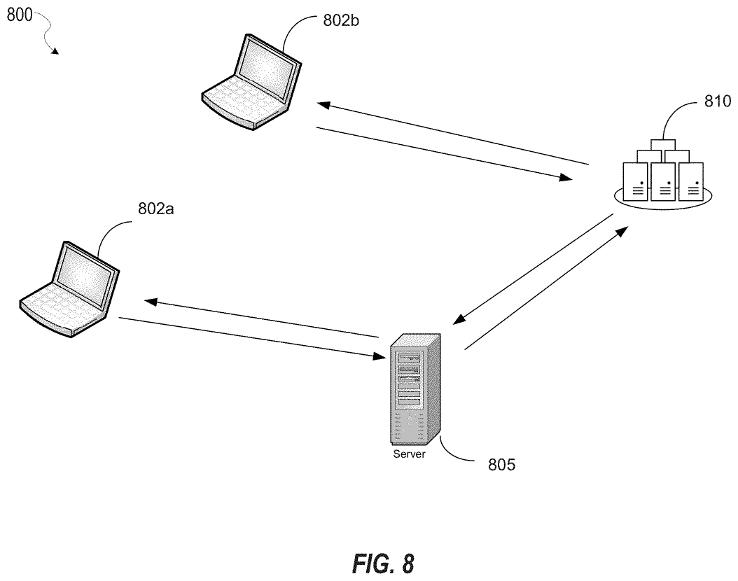

FIG. 8 is an overview diagram of a computer system that implements one or more of the disclosed embodiments. FIG. 8 shows computing devices 802a and 802b, a server 805, and a cloud computing implementation 810. The cloud computing implementation 810 may host an authentication service. The authentication service may compare authentication credentials provided by one or more of the computing device 802b and/or server 805 with credentials stored in an authentication database (e.g. 730). If the credentials match, the cloud computing implementation 810 may establish a session for the user account with the device submitting the authentication credentials.

The embodiments disclosed herein may be implemented by one or more of the computing device 802b and/or server 805. For example, in some aspects, one or more delay profiles discussed above may be configured on, and operate within, a single device, such as the computing device 802b.

In some other aspects, the disclosed embodiments may be implemented on the server device 805. In these embodiments, an account name or password may be entered at the client device 802a. The entered account name and/or password may then be provided to the server device 805 via a network. Additionally, information defining delays between entered characters of the account name and/or password may also be provided to the server device 805 via the network (e.g. information such as the delay values 104a-d shown in FIG. 1). The server device 805 may then apply a delay profile to the received entered password and/or account name to determine whether the delays meet the criterion defined in the delay profile. If the delays between the entered characters meet the requirements of the delay profile, the server device 805 may then provide the account name and/or password to an authentication service implemented by the cloud computing implementation 810. In these aspects, the delay profile may be configured separately on each of the client device 802a and the server device 805. In other embodiments, the delay profile may only be configurable via the server 805 and may be distributed to the client device(s) 802a-b. In some other aspects, the verification of acceptable delay values may be performed by the authentication service itself.

While the example embodiment shown in FIG. 8 and discussed above is described as hosting the authentication service on the describes the authentication service running on the cloud computing implementation 810, in other embodiments, the authentication service could run on any of the client devices 802a or 802b, or the server 805.

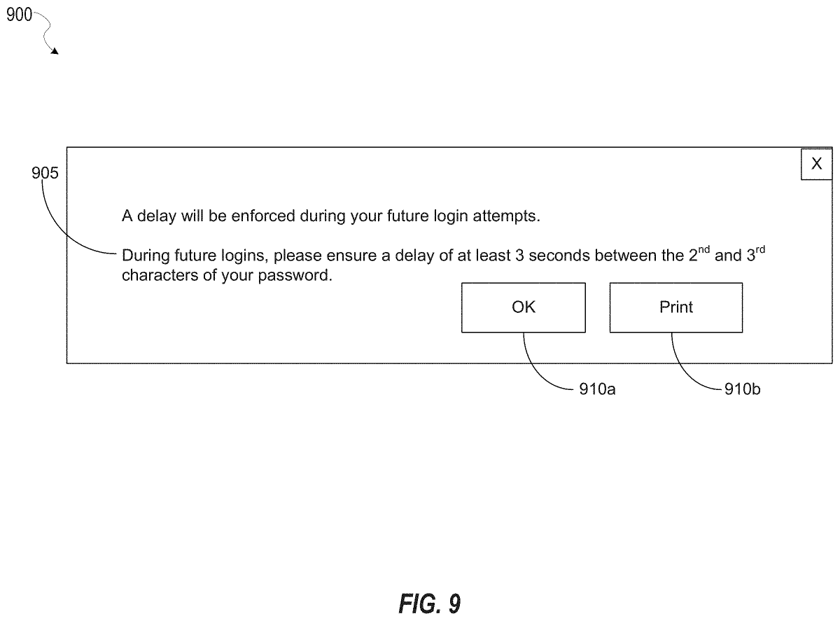

FIG. 9 shows an example user interface that may be implemented in at least one of the disclosed embodiments. The user interface 900 displays a notification when a system assigned or default delay criterion is set for an account. In some aspects, the system assigned or system assigned delay criterion may be applied to an account name or a password of the account. In some aspects, the system assigned delay criterion may apply to one delay between two characters of the account name and/or password. In other aspects, multiple delay criterion may be set by the system by default, for example, a first delay between two characters and a second delay between two other characters. The user interface 900 includes notification text, which displays a magnitude of a delay (“at least three seconds”) and a position of the delay (between the 2^{nd} and 3^{rd} characters). The notification also displays whether the delay must be between the account name or the password of the login credentials (in the example of FIG. 9, the delay is part of the password). The example of FIG. 9 also includes an ok button 910a and print button 910b. The print button allows the user to store off the information for later reference. One disadvantage of allowing the user to print the delay values is that it may reduce the security provided by the delay values, in the event the hardcopy is compromised. This may be an acceptable trade off between user convenience and security in some embodiments. Other embodiments may not provide the print button 910b. Some embodiments may also disable screen shots of the user interface 900, via techniques known in the art. Some embodiments may display the user interface 900 for a limited period of time, such as two or three seconds, and then close the user interface 900. This may improve security of the information displayed.

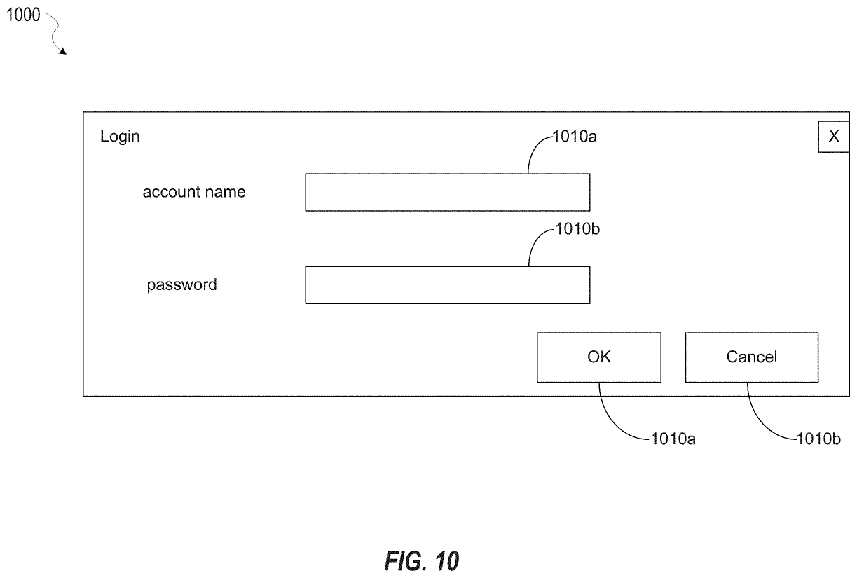

FIG. 10 is a login screen that may be implemented in one or more of the disclosed embodiments. The login screen 1000 includes an account name field 1010a and a password field 1010b. One or more of account name data entered via the account name field 1010a or password data entered via the password field 1010b may form a sequence of characters and data defining at least one delay between two of the sequence of characters. One or more of the account name data and/or password data may be evaluated against delay criterion as described above. If the account name data and/or password data does not meet the defined delay criterion, the login via user interface 1000 will fail. The login screen 1000 also includes an ok button 1010a and a cancel button 1010b. To perform authentication in some embodiments, account name data entered into the account name field 1010a and/or password data entered into the password field 1010b may be evaluated against data stored in the account name field 734 and/or password field 744 respectively.

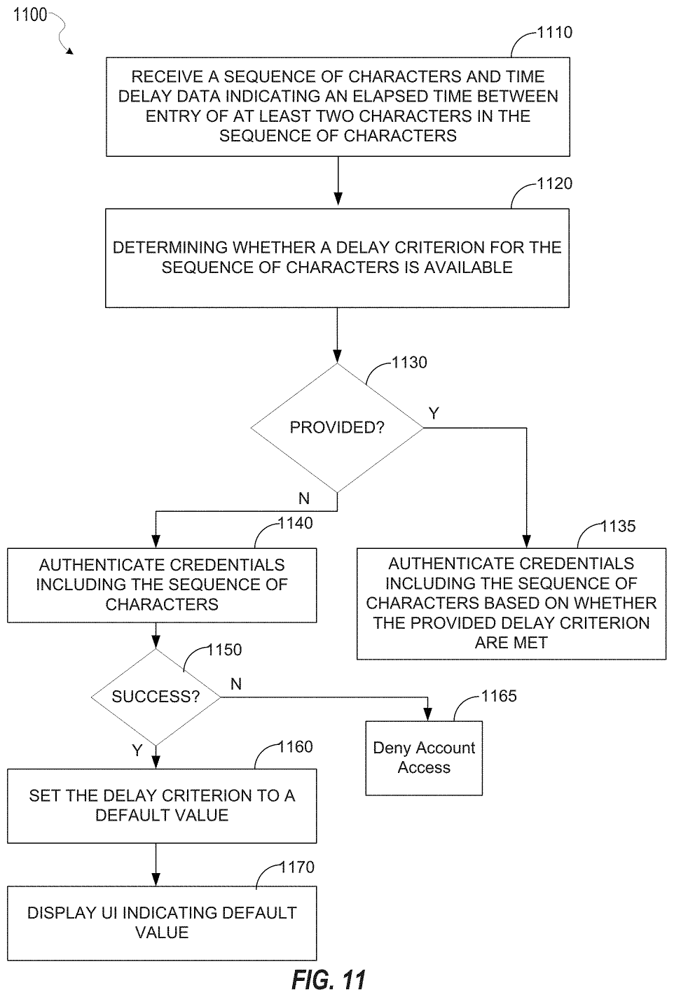

FIG. 11 is a flowchart for authenticating a user account based on authentication credentials. One or more of the functions discussed below with respect to FIG. 11 may be performed by hardware processing circuitry. For example, an electronic memory may store instructions that when executed configure the hardware processing circuitry to perform one or more of the functions discussed below with respect to FIG. 11. In some aspects, process 1100 discussed below with respect to FIG. 11 may be performed by a client device, such as any of client devices 802a or 802b. In some aspects, process 1100 may be performed by a server, such as server 805.

In operation 1110, a sequence of characters is received. In some aspects, the sequence of characters is received from a user interface, such as the user interface 1000 discussed above with respect to FIG. 10. For example, the sequence of characters may be received from the field 1010a (account name) or 1010b (password).

Also received is data defining an elapsed time between entry of at least two characters in the sequence of characters. As discussed above with respect to the example of FIG. 1, the sequence of characters is represented by characters 102a-d. A delay between each of the received characters 102a-e is represented by delays 104a-d. The sequence of characters may be entered by a user and may identify either an account name or a password. For example, if the sequence of characters is entered into an account name field, such as account name field 1010a, then the sequence of characters corresponds to an account name. If the sequence of characters is entered into a password field, such as password field 1010b, then the sequence of characters corresponds to a password.

Operation 1120 determines whether a delay criterion for the sequence of characters is available. In some aspects, operation 1120 may consult a database to determine if a delay criterion is defined for one or more of an account name or password for an account. For example, operation 1120 may search the account profile table 700 and/or the device profile table 710 for an account id or device id appropriate for the sequence of characters. If the profile identifier 704 or 714 respectively identifies a delay profile, then a delay criterion is available. If a delay profile is specified for the sequence of characters, process 1100 moves from operation 1130 to operation 1135, where credentials are authenticated. The credentials include the sequence of characters. The authentication is based on the delay criterion for the sequence of characters. For example, operation 1135 determines whether delays defined by the delay data meets the requirements specified in the delay profile indicating the delay criterion.

If no delay profile or delay criterion is defined for the sequence of characters in decision operation 1130, process 1100 moves to block 1140, where authentication proceeds based on the sequence of characters. For example, if the sequence of characters defines an account name, then authentication of the account name is attempted. If the sequence of characters defines a password, then authentication based on the password is attempted.

If the authentication is successful, process 1100 moves from decision operation 1150 to 1160, which sets the delay criterion to a default or system assigned value. In some aspects, the system assigned value may define a single delay criterion between two characters. For example, the system assigned value may set a delay criterion to require a delay between a second and third character of at least four (4) seconds. If the authentication is not successful, processing moves to block 1165 where access to the account is denied.

In operation 1170, a user interface is displayed indicating the system assigned value(s). For example, as shown in FIG. 9, one example user interface 900 displays a notification 905 indicating an example system assigned criterion.

As discussed above for example with respect to FIGS. 3-5, particular delay profiles may be applied based on time/date and/or location criterion. For example, process 1100 may identify one or more of a user and/or device on which the sequence of characters is to be applied. A list of delay profiles for the user, password, and/or device may then be obtained, for example, as may be configured via list box 604 and stored via tables 700 and/or 710 and/or 740. Starting from the top of the list, process 1100 may determine whether the first listed profile is to be applied given any date/time and/or location criterion that may be included in the delay profile (e.g. 726 of 727). If the first delay profile in the list does not apply because one or more of these criterion are not met, a second delay profile is analyzed to determine if it should apply given time/date and location of the device/user.

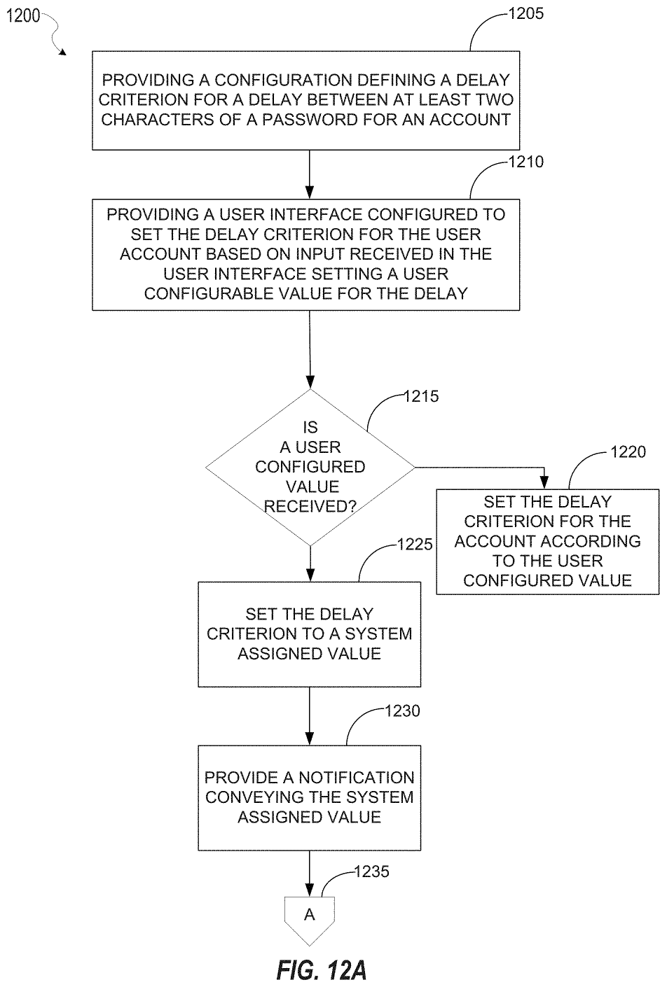

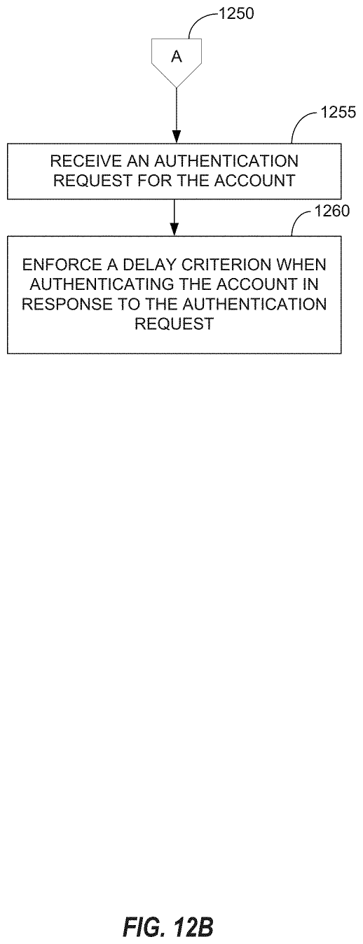

FIGS. 12A-B show a flowchart for authenticating an account based on authentication credentials. One or more of the functions discussed below with respect to FIGS. 12A-B may be performed by hardware processing circuitry. For example, an electronic memory may store instructions that when executed configure the hardware processing circuitry to perform one or more of the functions discussed below with respect to FIGS. 12A-B.

In operation 1205, a configuration defining a delay criterion for a delay between at least two characters of a password for an account is provided. In other words, providing a configuration such as this may include maintaining a data store such as the profile table 720 described above with respect to FIG. 7, which defines an acceptable delay range for a delay profile. The delay profile may then be selectively attached or associated with one or more accounts, as described above.

Profiles such as those described above in the example of FIG. 7 are not strictly required to be the only means of providing the configuration in operation 1205. For example, the configuration could be provided via a single delay value, and an indication of a character position to which the delay value is applied. For example, a configuration including a tuple such as <2, 3> may indicate, in some embodiments, that a two second delay is required after a third character in a password. In these implementations, an acceptable range may be inferred around the two second value, with the range calculated based on a predefined constant. For example, in some embodiments, the predefined constant is 0.2 seconds. In these embodiments, the acceptable delay range using the above example would be between 1.8 s and 2.2 seconds.

In operation 1210, a user interface is provided. The user interface is configured to set the delay criterion (of the configuration described above with respect to operation 1205) for the account based on input received in the user interface. The input sets a user configurable value for the delay. For example, as described above with respect to FIG. 2, the user interface 200 provides for setting of one or more user configurable values to define a delay profile. The delay profile is then assigned, for example, via the user interface 600 of FIG. 6, to a particular device, or account. However, delay profiles are not the only technique for providing the user interface. For example, the user interface could be implemented to provide for setting of the two integers discussed above (e.g. <2, 3>) that indicate a size of the delay and a position of the delay within a sequence of characters. The user configurable value may be any value within a valid range of values, but is defined based on user input, e.g. input received from a user interface. In some aspects, the user interface may not necessarily be a graphical user interface, but could instead be a simple ascii configuration file that defines the delay and character position.

Decision operation 1215 determines whether a user configurable value was received for a particular account. For example, in some aspects, the user interface discussed above with respect to operation 1210 may be configured to set a flag or other indication when a user-configured value is provided for the particular account. For example, in some aspects, the account profile table 700 may be searched to determine if the particular account is identified and associated with a profile. If not, decision operation 1215 may determine that no user configurable value was received. Otherwise, if an identifier of the account exists in the account profile table 700 and is associated with a profile, then decision operation 1215 determines that a user configurable value was received.

If the user configurable value was provided, process 1200 moves to block 1220, where the delay criterion for the account is set according to the user configured value. For example, if delay criterion were entered via the user interface 200, they may be stored in a datastore, such as one or more of the tables described above with respect to FIG. 7.

If no user configured value was provided, a system assigned value is assigned to the delay criterion in operation 1225. In various embodiments, the system assigned criterion may itself by configurable by a systems administrator. In some aspects, the system may determine a random system assigned value, such that the same values are not used for many accounts. In some aspects, both the delay value, and the position within characters of the password may be randomly determined. In some aspects, the position within characters of the password may be randomly determined based on a number of characters included in the password. Thus, for example, a long password may be assigned a random delay criterion between a second to the last character in the password and the last character, where this position wouldn't exist for a different user with a different, and shorter password. Thus, the system may dynamically adjust a range from which a random number is chosen based on a length of the password.

In operation 1230, a notification conveying the system assigned value is provided. For example, operation 1230 may display a user interface equivalent to or similar to the user interface 900, described above with respect to FIG. 9. The particular details of the notification may vary substantially from the example of FIG. 9, as FIG. 9 operates only as one example.

Turning to FIG. 12B, in operation 1255, an authentication request is received for the account. The authentication request may include one or more of an account name and/or password for the account. The password includes a sequence of characters. The authentication request may also indicate delays during entry of the sequence of characters. For example, if the character includes n characters, n−1 delays may be indicated by the authentication request, indicating delays between each of the n characters in the password. An example of characters in a password and associated delays between the characters is illustrated above in FIG. 1, showing a sequence of (n) characters 102a-e, and (n−1) delays 104a-d between each adjacent pair of characters in the sequence of characters 102a-e.

In operation 1260, a delay criterion is enforced when authenticating the account. For example, the delays indicated by the authentication request may be compared to one or more delays defined by a delay profile associated with the account. For example, in some aspects of operation 1260, a delay indicated in the authentication request may be compared to a delay range indicated by field 723 and 724 of the delay profile as defined by table 720. An ordinal position of the delay indicated in the authentication request may determine which delay range in the delay profile is applied, based on the position field 725.

As discussed above for example with respect to FIGS. 3-5, particular delays or delay profiles may be applied based on time/date and/or location criterion. For example, process 1200 may identify one or more of a user and/or device on from which the authentication request was received. A list of delay profiles for the user, password, and/or device may then be obtained, for example, as may be configured via list box 604 and stored via tables 700 and/or 710 and/or 740. Starting from the top of the list, process 1200 may determine whether the first listed profile is to be applied given any date/time and/or location criterion that may be included in the delay profile (e.g. 726 of 727). If the first delay profile in the list does not apply because one or more of these criterion are not met, a second delay profile is analyzed to determine if it should apply given time/date and location of the device/user.

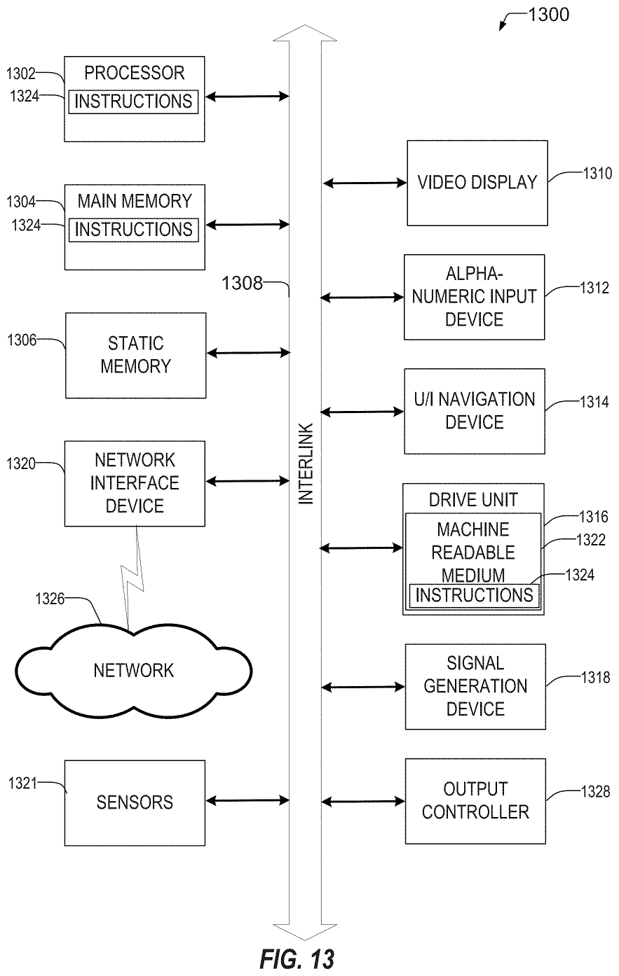

FIG. 13 illustrates a block diagram of an example machine 1300 upon which any one or more of the techniques (e.g., methodologies) discussed herein may perform. In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environment. The machine 1300 may be a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. In various embodiments, machine 1300 may perform one or more of the processes described above with respect to FIGS. 1-12B. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The machine 1300 may further include a display unit 1310, an alphanumeric input device 1312 (e.g., a keyboard), and a user interface (UI) navigation device 1314 (e.g., a mouse). In an example, the display unit 1310, input device 1312 and UI navigation device 1314 may be a touch screen display. The machine 1300 may additionally include a storage device (e.g., drive unit) 1316, a signal generation device 1318 (e.g., a speaker), a network interface device 1320, and one or more sensors 1321, such as a global positioning system (GPS) sensor, compass, accelerometer, or other sensor. The machine 1300 may include an output controller 1328, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 1316 may include a machine readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within static memory 1306, or within the hardware processor 1302 during execution thereof by the machine 1300. In an example, one or any combination of the hardware processor 1302, the main memory 1304, the static memory 1306, or the storage device 1316 may constitute machine readable media.

While the machine readable medium 1322 is illustrated as a single medium, the term “machine readable medium” may include a single medium or multiple media (e.g., a centralized or distributed database, and/or associated caches and servers) configured to store the one or more instructions 1324.

The term “machine readable medium” may include any medium that is capable of storing, encoding, or carrying instructions for execution by the machine 1300 and that cause the machine 1300 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1324 may further be transmitted or received over a communications network 1326 using a transmission medium via the network interface device 1320. The machine 1300 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of single-input multiple-output (SIMO), multiple-input multiple-output (MIMO), or multiple-input single-output (MISO) techniques. In some examples, the network interface device 1320 may wirelessly communicate using Multiple User MIMO techniques.

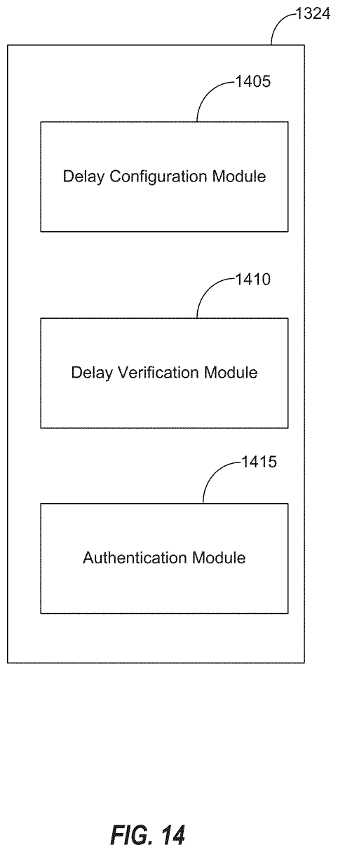

FIG. 14 is a block diagram of an example organization of the instructions 1324 discussed above with respect to FIG. 13. The instructions 1324 includes a delay configuration module 1405, a delay verification module 1410, and an authentication module 1415. The components illustrated in FIG. 14 may be included in one or more of a client device (e.g. 802a or 802b) and/or a server (e.g. 805). The delay configuration module 1405 may include instructions that configure hardware processing circuitry, such as the processor 1302, to display any of the configuration user interfaces of FIGS. 2-6, and store any resulting data in any of the appropriate tables described above with respect to FIG. 7. The delay configuration module may alternatively be considered to display other user interfaces to provide delay information for validating a password, as described above. The delay verification module 1410 includes instructions that configure hardware processing circuitry to verify whether an account name or password was entered in accordance with delay requirements for the account name or password, as discussed above. For example, the delay verification module 1410 may determine one or more delay profiles applicable to an account name or password, and determine whether the delays between characters of the account name or password conform with criterion defined by the delay profiles. The authentication module 1415 may authenticate a user account based on a provided account name and/or password. In some aspects, the authentication module 1415 may interface with an authentication service, such as an authentication service running within the cloud computing implementation 810, discussed above.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory; etc.

We claim:

1. A system comprising:
hardware processing circuitry;
a hardware memory storing instructions that when executed cause the hardware processing circuitry to perform operations, comprising:
providing a configuration defining a delay criterion for a delay between at least two characters of a password for an account;
providing a user interface configured to set the delay criterion for the account based on input received in the user interface setting a user-value for the delay;
if the user-configurable value for the delay is received, setting the delay criterion for the account according to the received user-configurable value;
if the user-configurable value for the delay is not received, setting the delay criterion for the account to a system-assigned value for the delay, and providing a notification conveying the system-assigned value for the delay;
receiving an authentication request for the account; and
enforcing the delay criterion when authenticating the account in response to the authentication request.

2. The system of claim 1, wherein the authentication request indicates the password and delays between entry of characters included in the password, and enforcing the delay criterion comprises confirming that the delays indicated by the authentication request conform with delays indicated by the delay criterion.

3. The system of claim 1, the operations further comprising causing display of the user interface, and receiving input from the user interface defining a user-configurable value for a delay between two character positions of a password for the account.

4. The system of claim 7, wherein the authentication request indicates delays between entry of characters of the password, and wherein enforcing the delay criterion comprises verifying the delays between characters of the password are in accordance with the user-configurable value defined by the input.

5. The system of claim 4, the operations further comprising receiving second input from the user interface defining a second user-configurable value for a delay between two additional character positions of the password for the account, and wherein enforcing the delay criterion comprising verifying the delays between characters of the password are in accordance with the second user-configurable value for the delay between the two additional character positions.

6. The system of claim 1, the operations further comprising receiving input from the user interface defining a lower bound of a delay range and an upper bound of the delay range, the delay range defining a delay requirement between a first character in the sequence of characters and a second character in the sequence of characters.

7. The system of claim 1, wherein the delay criterion further defines a second required time delay range between a third character and a fourth character in the sequence of characters.

8. The system of claim 1, wherein the authentication request indicates a location of a client device generating the authentication request, and determining the delay criterion based on the location.

9. The system of claim 8, where enforcing the delay criterion comprising determining the delay criterion based on a date and time of day.

10. A method, comprising:
providing a configuration defining a delay criterion for a delay between at least two characters of a password for an account;
providing a user interface configured to set the delay criterion for the account based on input received in the user interface setting a user-value for the delay;
if the user-configurable value for the delay is received, setting the delay criterion for the account according to the received user-configurable value;
if the user-configurable value for the delay is not received, setting the delay criterion for the account to a system-assigned value for the delay, and providing a notification conveying the system-assigned value for the delay;
receiving an authentication request for the account; and
enforcing the delay criterion when authenticating the account in response to the authentication request.

11. The method of claim 10, wherein the authentication request indicates the password and delays between entry of characters included in the password, and enforcing the delay criterion comprises confirming that the delays indicated by the authentication request conform with delays indicated by the delay criterion.

12. The method of claim 10, the operations further comprising causing display of the user interface, and receiving input from the user interface defining a user-configurable value for a delay between two character positions of a password for the account.

13. The method of claim 11, wherein the authentication request indicates delays between entry of characters of the password, and wherein enforcing the delay criterion comprises verifying the delays between characters of the password are in accordance with the user-configurable value defined by the input.

14. The method of claim 13, the operations further comprising receiving second input from the user interface defining a second user-configurable value for a delay between two additional character positions of the password for the account, and wherein enforcing the delay criterion comprising verifying the delays between characters of the password are in accordance with the second user-configurable value for the delay between the two additional character positions.

15. The method of claim 10, the operations further comprising receiving input from the user interface defining a lower bound of a delay range and an upper bound of the delay range, the delay range defining a delay requirement between a first character in the sequence of characters and a second character in the sequence of characters.

16. The method of claim 10, wherein the delay criterion further defines a second required time delay range between a third character and a fourth character in the sequence of characters.

17. The method of claim 10, wherein the authentication request indicates a location of a client device generating the authentication request, and determining the delay criterion based on the location.

18. The method of claim 17, where enforcing the delay criterion comprising determining the delay criterion based on a date and time of day.

19. An apparatus, comprising:
means for providing a configuration defining a delay criterion for a delay between at least two characters of a password for an account;
means for providing a user interface configured to set the delay criterion for the account based on input received in the user interface setting a user-value for the delay;
means for setting the delay criterion for the account according to user-configurable value received via a configuration user interface;
means for setting the delay criterion for the account to a system-assigned value for the delay in response to the user-configurable value for the delay not being received;
means for receiving an authentication request for the account; and
means for enforcing the delay criterion when authenticating the account in response to the authentication request.

20. The apparatus of claim 19, wherein the authentication request indicates the password and delays between entry of characters included in the password, and the means for enforcing the delay criterion is configured to confirm that the delays indicated by the authentication request conform with delays indicated by the delay criterion.
